(19) United States
(12) Patent Application Publication
(10) Pub. No.: US 2016/0082587 A1
(43) Pub. Date: Mar. 24, 2016

(54) Tree Decorating Assistant

(71) Applicant: Rodney L. Hairfield, Mt Pleasant, SC (US)

(72) Inventor: Rodney L. Hairfield, Mt Pleasant, SC (US)

(21) Appl. No.: 14/798,325

(22) Filed: Jul. 13, 2015

Related U.S. Application Data
(60) Provisional application No. 62/071,382, filed on Sep. 22, 2014.

(51) Int. Cl. B25J 1/04; F21S 4/00

(52) U.S. Cl. CPC B25J 1/04; F21S 4/001; F21W 2121/04

(57) ABSTRACT

A tree decorating assistant apparatus is disclosed for applying ornaments and lighting to a Christmas (or other seasonal) tree and comprising a decoration support element, provided by a replication of animal antlers (or horns); a decorative animal head section to provide support for the lighting support and is consistent with the animal-related lighting support section configuration; and a handle section to control, lift and permit placement of ornaments and string lighting sections at different points on the tree. Further, to provide for assistance in the case of large and/or tall trees, multiple handle extension elements are attachable to the handle section for reaching greater and greater heights.

### CROSS-REFERENCE TO RELATED APPLICATION

The instant application claims the benefit of previously filed Provisional Application No. 62/071,382 filed in the US Patent and Trademark Office on Sep. 22, 2014.

### BACKGROUND

1. Field of the Invention

The invention relates to decorating with lights and/or ornaments in any season or time of year, but the disclosed invention relates primarily to Christmas tree decorating. Particularly, the invention relates to assisting in hanging Christmas tree lighting and ornaments. Most particularly, the invention provides assistance where the upper portion of a Christmas tree is of a height where the decorator may not easily reach for placing ornaments and string, or other, lighting on the tree.

2. Description of the Prior Art

U.S. Pat. No. 5,813,747 to B. J. Kale discloses Christmas tree lights displayed on a tree. The Christmas tree lights comprise a wire connected to a power means and further comprise a plurality of wire lights electrically spliced within the wire. These lights further comprise a light housing which includes an opening therein within which a wire light is removeably positioned. This is well known. Also well known is that getting these lights on the upright Christmas tree, especially a tall tree, is no easy task.

Of course, the obvious prior art in the field of invention for solving the problem of hanging ornamental, or decorative, lighting at significant heights, especially in Christmas trees of significant heights, is the use of a ladder to raise the decorator to a height to be able to place and position the ornaments and/or lighting in the upper portion of the tree. Most ladders, when unfolded, provide an awkward position from which to lean out from, in the direction of the tree, safely. Also, the positioning of the ladder near enough to the tree to accomplish its purpose becomes an inconvenience to accessing the tree for placement and positioning other decorations. Therefore, the ladder, if a solution at all, is an unsatisfactory one for multiple reasons.

### BRIEF DESCRIPTION OF THE INVENTION

The invention tree decorating assistant, affectionately referred to as Henry™, provides an extended (and further extendable) solution to control the placement and positioning of ornaments or the light string while comfortably and safely remaining on the floor. The tree decorating assistant is designed to provide means for controlling ornaments or the light string at its distal end until it is transferred to a desired tree branch and in a preferred location thereon. As will be described in greater detail herein, the invention tree decorating assistant will permit extended reach to perform this necessary task in a safe and convenient manner.

### BRIEF DESCRIPTION OF THE DRAWINGS

FIG. 1 provides a frontal view of the tree decorating assistant apparatus primary section, including a decoration support section 1a, a decorative head section 1b, and a handle section 1c. Examples of decorations requiring the decoration support section include ornaments and string lighting sections.

FIG. 2 provides a side view of the tree decorating assistant apparatus primary section, including a decoration support section 2a, a decorative head section 2b, and a handle section 2c.

FIG. 3 also provides a frontal view of the tree decorating assistant apparatus primary section along with perspective views of multiple extension secondary sections 3a, 3b, and 3c.

### DETAILED DESCRIPTION OF THE INVENTION

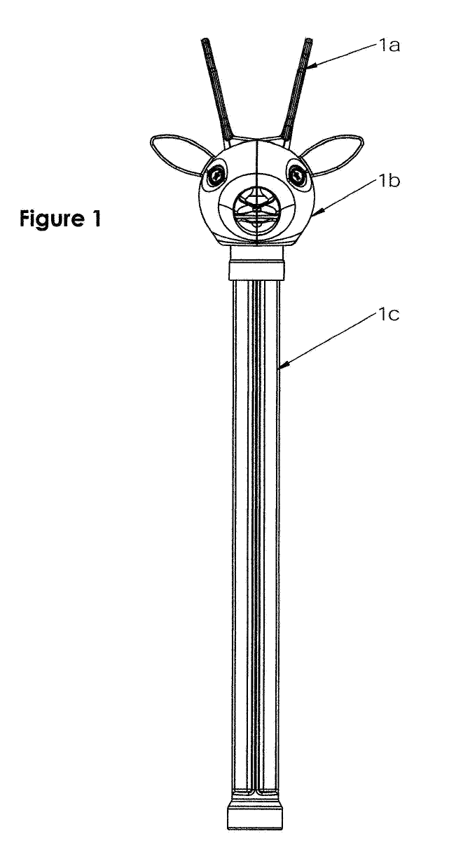

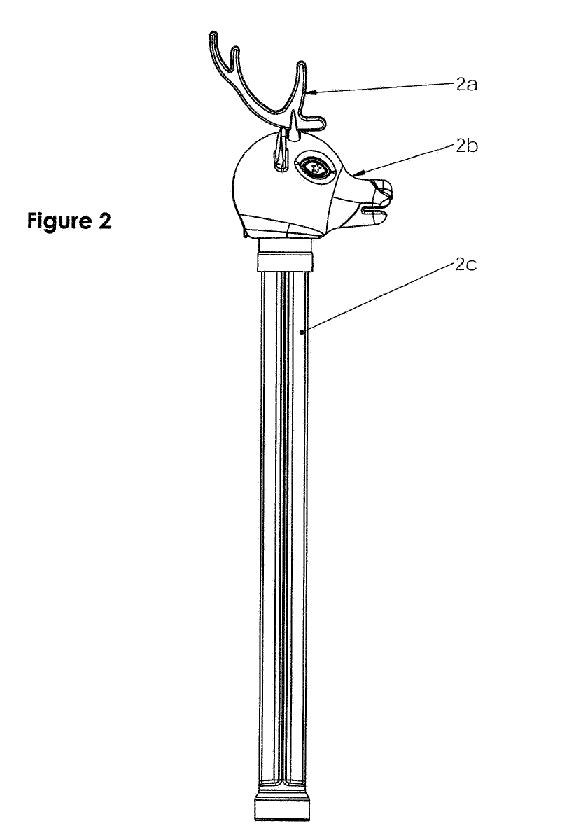

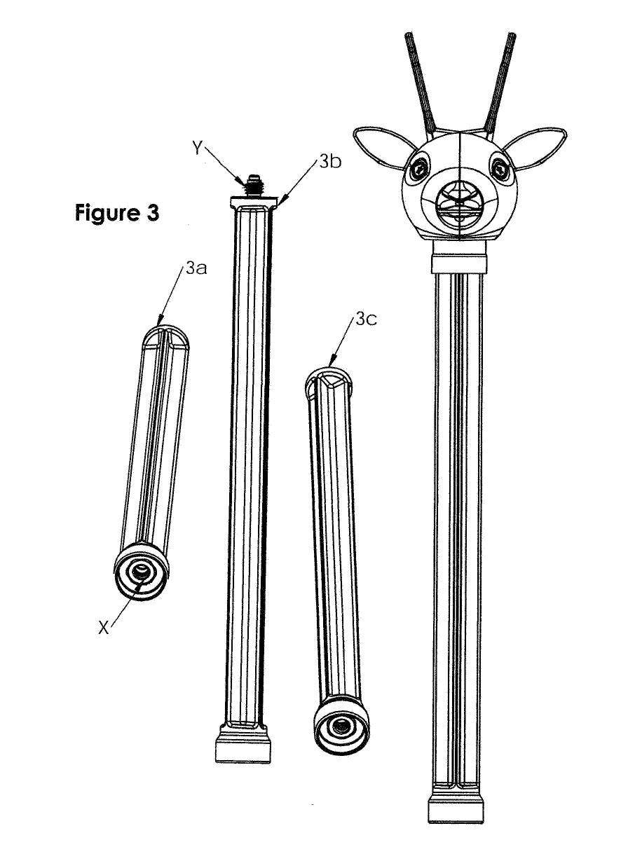

As seen from the above described figures, the tree decorating apparatus is designed with functional antlers positioned atop a reindeer head to support an ornament or a section of string lighting while lifting it to a desired height and position of the tree to permit and maintain control of the ornament or lighting section until such support is transferred to the desired position on the tree (see FIGS. 1 and 2). In particular, the side view depicted in FIG. 2 discloses antlers designed to work together to provide the needed decoration support. Also, the tree decorating assistant apparatus is adaptable for different heights as indicated in FIGS. 3, 3a, 3b, and 3c.

The disclosed and claimed tree decorating assistant includes: a decoration support element 1a, provided by a replication of deer antlers; a decorative head section 1b to provide support for the decoration support 1a; and a handle section 1c to control, lift and permit placement of ornaments or string lighting sections at different points on the tree. FIGS. 3a, 3b, and 3c show additional handle extension elements to provide adaptations to the invention permitting placement of ornaments or string lighting sections at position points on the tree at varying heights. This permits decoration positioning over the entire tree without resort to use of a ladder and permitting the decorator's feet to remain safely on the floor or ground.

While the depiction of the invention in the figures show a particular horned or antlered animal, a deer (or, specifically, a reindeer), such exemplary figures are merely preferred embodiments. While the reindeer has a particular connection to the Christmas season, the instant invention disclosure is intended to include additional specific animals that could be used to represent the different elements of the tree decorating assistant apparatus. This is particularly so where other animals may be connected to other seasons represented by decorations that may include lighting and ornaments, such as a rabbit at Easter, etc. Other than as depicted in the figures shown, the decoration support element could be represented by different animals with antlers or horns, or even rabbit ears in the instance of the use of a rabbit's head as the decorative head section to support such ears. The horns and decorative head section easily could be designed to represent a cow or steer or bull or a Big Horn sheep. The antlers and decorative head section easily could be designed to represent an elk or moose, for example. Thus, the intended disclosure of the tree decorating assistant apparatus is not intended to be limited to a particular chosen animal reference; rather it is only limited by providing the elements for supporting an ornament or a section of string lighting via a decoration support element, a decorative head element to support the decoration, and a handle to control, lift and permit placement of the decoration (i.e., ornament or lights) at a desired position and height on the tree.

While the tree decorating assistant apparatus invention disclosed herein may be constructed of a lightweight metal, such as aluminum, a preferred embodiment of the apparatus is constructed of a plastic material, which provides necessary strength to support the ornaments and/ or lights, but doesn't add unnecessary additional weight for the user to support. The additional handle section elements may be added for providing adaptability of the apparatus to be used to position ornaments and string lighting sections at various heights, especially in instances of the popular use of a tall tree. The connection is easily made by providing an opening X at the end of the handle section away from the decorative head section for connecting one of the handle extension elements via a projection Y for one end of such extensions for fitting into the opening X. Additional extension elements may be added similarly by provision of an opening X at one end of the extension element and a projection Y at its opposite end.

While the present general inventive concept has been illustrated by description of some embodiments, and while the illustrative embodiments have been described in some detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept, and disclosed embodiments thereof.

It is also noted that numerous variations, modifications, and additional embodiments are possible, and, accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Accordingly, while the present generally described invention has been illustrated by description of several embodiments, it is not the intention of the applicant to restrict or in any way limit the scope of the invention to such descriptions and illustrations. Instead, the descriptions, drawings, and claims herein are to be regarded as illustrative in nature, and not as restrictive, and additional embodiments will readily appear to those skilled in the art upon reading the above description and drawings.

What is claimed is:

1. A tree decorating assistant apparatus for controlling, lifting and permitting placement of decorations at different locations on a tree comprising: a decoration support section; a decorative head section; and a handle section.

2. The tree decorating assistant apparatus of claim 1 wherein the decoration support section is a replication of appendages on an animal's head selected from the group of head appendages consisting of antlers, horns, and ears and the decorations are selected from the group consisting of ornaments and sections of string lighting.

3. The tree decorating assistant apparatus of claim 2 wherein the decorative head section is a replication of an animal's head selected from the group of animal heads consisting of cows, bulls, antelopes, deer, reindeer, elk, great horned sheep rams, rabbits and hares.

4. The tree decorating assistant apparatus of claim 3 wherein the selected decoration support section is appropriate to the selected animal head.

5. The tree decorating assistant apparatus of claim 1 wherein the handle section is extendable in length by addition of at least one of a multiple of additional handle section elements.

6. The tree decorating assistant apparatus of claim 4 wherein the handle section is extendable in length by addition of at least one of a multiple of additional handle section elements.

7. The tree decorating assistant apparatus of claim 3 wherein the decoration support section is a replication of antlers and the decorative head section is selected from the group of animal heads consisting of a deer, a reindeer, an antelope, and an elk.

8. The tree decorating assistant apparatus of claim 3 wherein the decoration support section is a replication of ears and the decorative head section is selected from group of animal heads consisting of a rabbit and a hare.

9. The tree decorating assistant apparatus of claim 3 wherein the decoration support section is a replication of horns and the decorative head section is selected from the group of animal heads consisting of a cow, a bull, a steer and a great horned sheep ram.

10. A method for controlling, lifting and placing sections of string lighting at different locations on a tree by use of a tree decorating assistant apparatus comprising a decoration support section, a decorative head section, and a handle section.

11. The method of claim 10 wherein the decoration support section is a replication of appendages on an animal's head selected from the group of head appendages consisting of antlers, horns, and ears.

12. The method of claim 11 wherein the decorative head section is selected from the group of animal heads consisting of a cows, bulls, antelopes, deer, reindeer, elk, great horned sheep rams, rabbits and hares.

13. The method of claim 11 wherein the selected decoration support section is appropriate to the selected animal head.

14. The method of claim 10 wherein the handle section is extendable in length by addition of at least one of a multiple of additional handle section elements.

15. The method of claim 13 wherein the handle section is extendable in length by addition of at least one of a multiple of additional handle section elements.

16. The method of claim 13 wherein the decoration support section is a replication of antlers and the decorative head section is selected from the group of animal heads consisting of a deer, a reindeer, an antelope, and an elk.

17. The method of claim 13 wherein the decoration support section is a replication of ears and the decorative head section is selected from group of animal heads consisting of a rabbit and a hare.

18. The method of claim 13 wherein the decoration support section is a replication of horns and the decorative head section is selected from the group of animal heads consisting of a cow, a bull, a steer and a great horned sheep ram.

19. The method of claim 13 wherein the decoration support section is a replication of horns and the decorative head section is selected from the group of animal heads consisting of a cow, a bull, a steer and a great horned sheep ram.
